(19) United States
(12) Patent Application Publication
(10) Pub. No.: US 2006/0209410 A1
(43) Pub. Date: Sep. 21, 2006

(54) Method and apparatus for compensation or amelioration of lens field curvature and other imaging defects by utilizing a multi-wavelength setting illumination source

(76) Inventors: Adlai H. Smith, Escondido, CA (US); Robert O. Hunter JR., Snowmass Village, CO (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/378,811

(22) Filed: Mar. 17, 2006

Related U.S. Application Data
(60) Provisional application No. 60/663,477, filed on Mar. 18, 2005.

(51) Int. Cl. G02B 27/44

(52) U.S. Cl. 359/565

(57) ABSTRACT

Methods and apparatus for correcting imaging defects, particularly focus defects induced by the lens or scan, in a projection imaging tool (PIT) are described. An illumination source is provided that can operate either simultaneously or alternately, at two or more discrete wavelength settings. The repeatable imaging defects of the PIT are measured. The cross field lens chromatic response is characterized at multiple discrete wavelength settings. Then, a compensating arrangement is designed tailored to compensate for the imaging defects and is used in the PIT.

### REFERENCE TO PRIORITY DOCUMENT

This application claims the benefit of priority of U.S. Provisional Patent Application Ser. No. 60/663,477, entitled “Method and Apparatus for Compensation or Amelioration of Lens Field Curvature and other Imaging Defects by Utilizing a Multi-Wavelength Setting Illumination Source”, filed Mar. 18, 2005. Priority of the filing date of Mar. 18, 2005 is hereby claimed, and the disclosure of U.S. Provisional Patent Application Ser. No. 60/663,477 is hereby incorporated, in its entirety, by reference.

### BACKGROUND OF THE INVENTION

1. Field of Invention

The present invention relates generally to processes for semiconductor manufacturing and more particularly to the optical correction of steppers and scanners for optical and mechanical deficiencies that impact their imaging performance.

2. General

Improvements in microlithography have been driven by the increasing capability of steppers and scanners (See J. Mulkens et al, “ArF Step And Scan Exposure Systems For 0.15 Micron and 0.13 micron Technology Node?, SPIE Conference on Optical Microlithography XII, 1999 pp. 506-521 and Twin Scan 100 Product Literature”, ASML) by extending both the potential capability (increased NA, shorter wavelength), decreasing the effects of aberrations (See “Plate Correction of Imaging Systems”, McArthur et al, U.S. Pat. No. 5,392,119, Feb. 21, 1995 and “Plate Correction Technique for Imaging Systems”, Mc Arthur et al, U.S. Pat. No. 5,640,233, Jun. 17, 1997), amelioration of mechanical errors (See “Process for Amelioration of Scanning Synchronization Error”, A. Smith et al, U.S. patent application Ser. No. 10/844,757, filed May 12, 2004), and improvements in process techniques (See “Depth of Focus Enhancement by Wavelength Modulation: Can We RELAX and Improve Focus Latitude?”, I. Lalovic et al, ARCH Interface, 2003, p. 9 and “Method And Apparatus For Enhancing The Focus Latitude in Lithography”, Pei-Yang Yan, U.S. Pat. No. 5,303,002, Apr. 12, 1994). As the k1 value steadily decreases, the impact of aberrations, mechanical imperfections, and decreased focus latitude can sharply limit or slow down manufacturing deployment of future technology nodes (esp. <=70 nm).

One class of techniques for improvement of projection imaging tool (PIT) performance is based on altering the input illumination spectrum and using the inherent lens or imaging objective chromatic aberration to effectively increase the depth of focus, DOF, (See “Depth of Focus Enhancement by Wavelength Modulation: Can We RELAX and Improve Focus Latitude?” and U.S. Pat. No. 5,303,002, supra). This class of technique is inherently applicable to DUV tools utilizing excimer lasers because of the inherently large amounts of chromatic aberration present. The improvement in DOF comes at the expense of contrast loss so these factors must be balanced out in a complicated way that depends on the specific mask geometry and process details. This complication therefore limits the widespread applicability of this technique.

It would be desirable to have techniques for uniformly improving PIT performance across all processes without sacrificing contrast or other imaging metrics.

### SUMMARY OF THE INVENTION

Techniques for correcting imaging defects, particularly focus defects induced by the lens or scan, in a PIT are described. These are imaging defects that affect the average image performance. They can be either mechanically (Z-scan synchronization error as described and measured in “Apparatus And Process For Determination Of Dynamic Scan Field Curvature”, A. Smith et al, U.S. patent application Ser. No. 10/833,781, filed Apr. 28, 2004) or optically induced (see “Apparatus And Process For Determination Of Dynamic Lens Field Curvature”, U.S. patent application Ser. No. 10/833,557, filed Apr. 28, 2004; “Apparatus And Process For The Determination Of Static Lens Field Curvature”, A. Smith et al, U.S. patent application Ser. No. 10/844,939, filed May 12, 2004; and “Apparatus, Method of Measurement And Method of Data Analysis For Correction of Optical System”, A. Smith et al, U.S. Pat. No. 5,828,455, Oct. 27, 1998). These imaging defects are corrected by utilizing a chromatically broadened source and inserting an optically compensating arrangement in the PIT beam train to ameliorate some of the system imaging defects. By targeting or correcting average, repeatable imaging defects, a net improvement in performance is achieved while also getting the improved focus latitude of U.S. Pat. No. 5,303,002, supra. In one embodiment an illumination source is provided in the PIT that can operate either simultaneously or alternately at two or more discrete wavelength settings. In the case of an excimer laser source, it can either be operated at different wavelengths for different pulses, or at multiple wavelengths simultaneously. Next the repeatable system defects are measured. The defects that are typically most easily correctible are Zernike aberrations with the largest changes per unit wavelength shift; typically focus in refractive lens designs (See a4, “Behavior of Lens Aberrations As A Function of Wavelength On KrF And ArF Lithography Scanners”, M. Terry et al, SPIE Vol. 4346, 15:24 2001). A different balance or mixture may be used in catadioptric PIT (See High Numerical Aperture Catadioptric Lens”, D. Williamson, U.S. Pat. No. 6,486,940, Nov. 26, 2002).

In the course of measuring or characterizing the imaging defects, it is typical to also measure the chromatic response of these same aberrations to wavelength shifts. This may be done by repeating the aforementioned measurement at several discrete wavelengths. Next, based on the particular scanner or stepper configuration and on the class of imaging defects that are being compensated for, an optical compensating arrangement may be designed and installed in the PIT.

In one embodiment, a method for correcting imaging defects in a projection imaging tool includes providing an illumination source with an output at two or more discrete wavelength settings. Then, measurements of repeatable imaging defects and crossfield lens chromatic response of the projection imaging tool are made. Using these measurements a compensating arrangement is designed for use in the projection imaging tool to correct imaging defects.

Examples of crossfield chromatic response include tilt distortion and lens distortion. Examples of repeatable imaging defects include stage translation errors, scan synchronization errors, and dynamic lens field curvature. An example of the compensating arrangement is a dual zone polarizing beam splitter.

An illumination source with an output at two or more discrete wavelength settings can be, for example, a mercury lamp and a notch rejection filter, or an excimer laser and a notch rejection filter.

Techniques described can be used in the manufacture of semiconductor chips and devices. For example, an illumination source with an output at two or more discrete wavelength settings can be provided. The repeatable imaging defects and crossfield lens chromatic response of the projection imaging tool can be measured. Based on the measurements, a compensating arrangement for use in the projection imaging tool to correct imaging defects can be designed. Then, one or more layers of the semiconductor device can be exposed with the projection imaging tool.

Other features and advantages of the present invention should be apparent from the following description of the preferred embodiment, which illustrates, by way of example, the principles of the invention.

### BRIEF DESCRIPTION OF THE DRAWINGS

FIG. 1 is a flow diagram illustrating an embodiment for correcting projection imaging tool imaging defects.

FIG. 2a shows a Hg lamp spectral line before utilizing notch rejection filter.

FIG. 2b shows a Hg lamp spectral line after utilizing notch rejection filter.

FIG. 3a shows the line narrowed excimer laser spectral lineshape, single wavelength operation.

FIG. 3b shows the excimer laser spectral lineshape, dual wavelength operation.

FIG. 3c shows polarization fractions for excimer laser dual wavelength operation.

FIG. 4 shows the illumination source required for the 1^{st} embodiment.

FIG. 5a shows the dual zone polarizing beam splitter.

FIG. 5b is a table of PBS transmissions for each zone.

FIG. 6 shows the location of polarizing beam splitter within source optic beamtrain.

FIG. 7 shows the spectral heights of λ1 and λ2 components of illumination source.

FIG. 8 is a schematic of illuminator beamtrain for the 2^{nd} embodiment.

FIG. 9a shows the dual zone translating polarizing beam splitter.

FIG. 9b is a table of PBS transmission properties in each zone.

FIG. 10 is a block diagram of an example of a projection imaging tool.

### DETAILED DESCRIPTION OF THE INVENTION

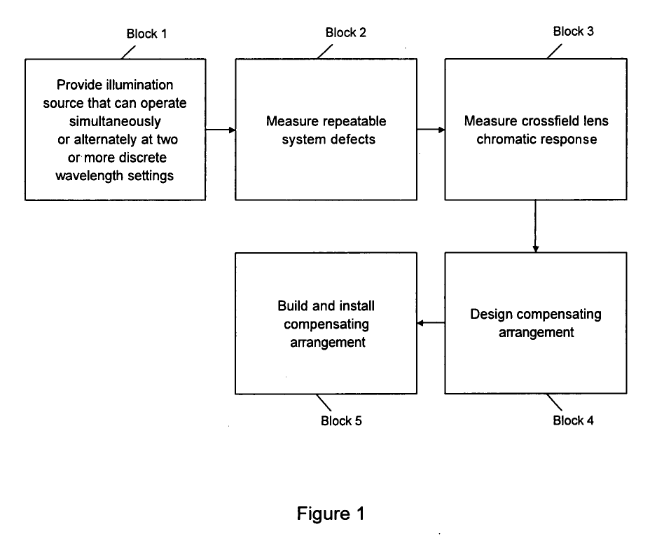

FIG. 1 is a flow diagram illustrating an embodiment for correcting projection imaging tool imaging defects.

Provide Illumination Source

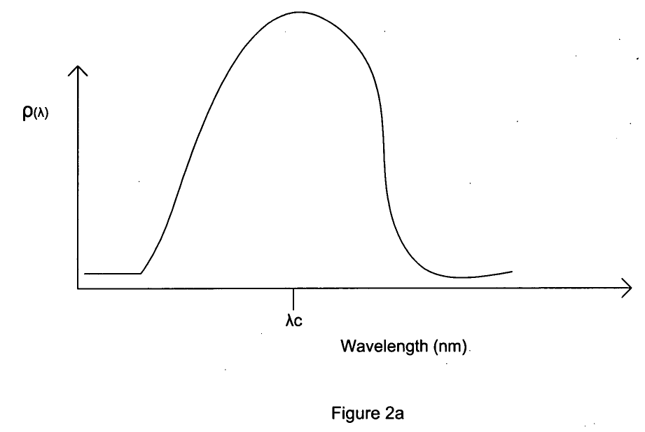

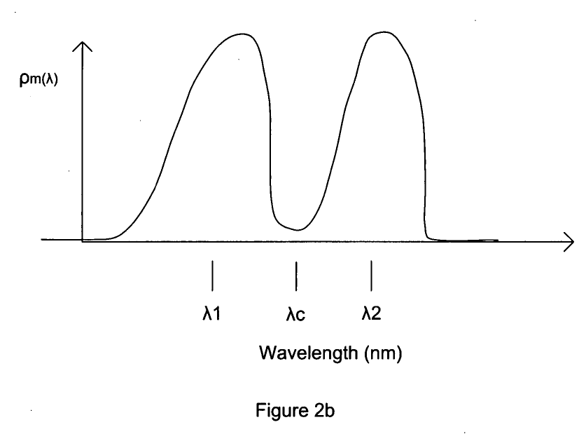

Referring to FIG. 1, Block 1, an illumination source that operates either simultaneously or alternately at two or more discrete wavelengths is provided. FIGS. 2a and 2b show how a high pressure mercury arc lamp spectrum is modified from its original spectrum (FIG. 2a, ˜10 nm FWHM linewidth) with peak at λ_{c} and by the insertion of a notch rejection filter (not shown) with ˜5 nm rejection band is transformed, FIG. 2b, into a double peaked line with peaks at λ1 and λ2 respectively. These separate line peaks and their corresponding support may also be separately polarized (vide infra).

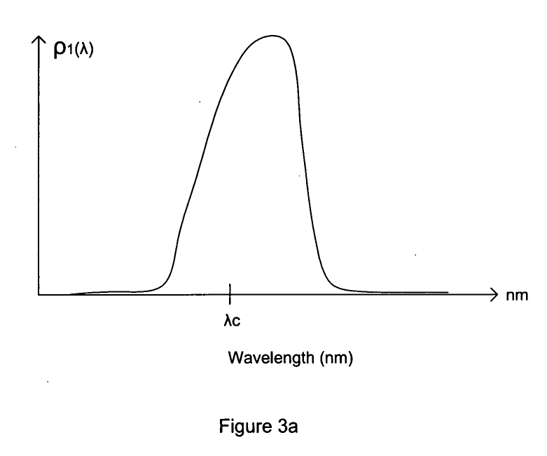

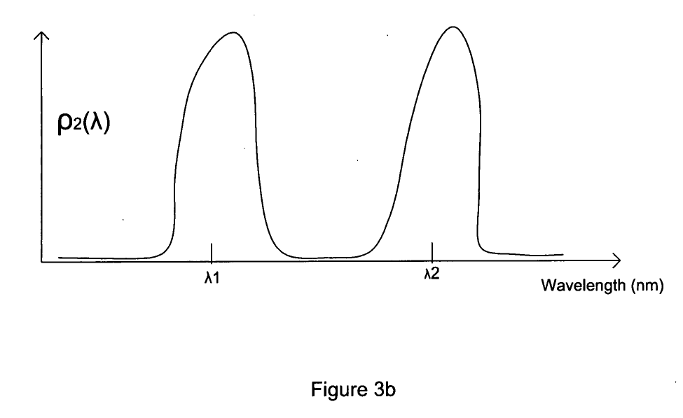

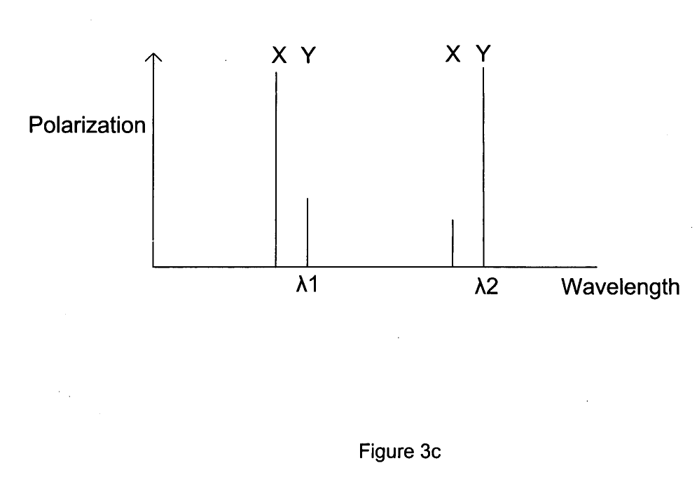

FIG. 3a shows a line narrowed, excimer laser lineshape. Because of strong chromatic aberrations in projection lens beamtrains, the natural linewidth of a discharge excited excimer laser, (/100 picometers (pm) bandwidth) must be line narrowed to approximately 1-3 pm (See Excimer Laser Lithography, K. Jain, SPIE Optical Engineering Press 101:114, 1990). This strong narrowing means there is opportunity to create multiple spectral lines, for example by using a notch rejection filter, (FIG. 3b, two shown) operating under the same spectral gain curve. Since existing lithographic projection lenses exhibit strong chromatic effects over the breadth of the gain curve, sufficiently separated peaks (FIG. 3b, λ2−λ1/1 pm) will exhibit different lens aberrations. Further, we can separately polarize the light from each spectral peak and corresponding support (FIG. 3c, X and Y polarization fractions). By support we mean wavelength region where spectral density is non-negligible.

Measure Repeatable System Defects

Returning to FIG. 1, in Block 2, repeatable system defects of the image delivery system are measured. These system defects can include, for example, lens aberrations and, in the case of scanners, repeatable scan synchronization error. The repeatable system defects of interest are determined primarily by the capabilities at our disposal (FIG. 1, Block 4) for correcting them. Relevant lens aberrations are subsets or special cases of crossfield Zernike coefficients aⱼ (x, y), that combine to express the lens phase aberrations as:

$$\begin{matrix}Φ ( nx , ny ; x , y ) = phase aberration of lens at \\ project field position ( x , y ) \\ = {\sum }_{j = 1}^{N} {a}_{j} ( x , y ) {Z}_{j} ( \frac{{n}_{x}}{NA} , \frac{{n}_{y}}{NA} )\end{matrix} \qquad ( Equation 1 )$$

where Zⱼ(;,β) are the standard Zernike polynomials (See “Zernike Annular Polynomials For Imaging Systems With Annular Pupils”, V. Mahajan 342:354). Crossfield Zernike coefficients a2 and a3 (tilt or lens distortion) are best measured using the methods of “Method and Apparatus for Self-Referenced Projection Lens Distortion Mapping”, A. Smith et al, U.S. Pat. No. 6,573,986, Jun. 3, 2003 and “Method and Apparatus for Self-Referenced Dynamic Step and Scan Intra-Field Lens Distortion”, A. Smith et al, U.S. Pat. No. 6,906,780, Jun. 14, 2005. Using those techniques, the effects of higher order (a5, a6 . . . ) Zernike coefficients and stage translation errors are minimized, or eliminated. A4 (focus Zernike) is best measured using the methods of U.S. patent application Ser. Nos. 10/833,557 and 10/844,939, supra since they minimize, or eliminate, the effect of wafer height variations. Higher order Zernikes (a5, a6 . . . ) are best measured using the methods of U.S. Pat. No. 5,828,455, supra and “Apparatus, Method of Measurement and Method of Data Analysis For Correction of Optical System”, A. Smith et al, U.S. Pat. No. 5,978,085, Nov. 2, 1999. Equation 1 is the general expression for a static field lens aberration. When assessing dynamic scan aberrations the phase aberration, Φ, is independent of the scan direction coordinate, y. Therefore;
Φ=Φ(nx,ny;y) for scanners (Equation 2)

The other class of potentially correctable system defects appear during dynamic scan and are the repeatable part of the transverse and Z-scan synchronization error. Taken together they are (See, U.S. patent application Ser. No. 10/833,781, supra and U.S. Pat. No. 6,906,303):

$$\begin{matrix}( Δ X , Δ Y , Δ Z ) ( x , y ) = repeatable part of \\ scan sync error \\ ( \begin{matrix}\begin{matrix}{dX}_{S} ( y ) , \\ {dY}_{S} ( y ) + x * {YAW}_{S} ( y ) ,\end{matrix} \\ {dZ}_{S} ( y ) + x * {R}_{S} ( y )\end{matrix} )\end{matrix} \qquad ( Equation 3 )$$

where:

x,y=position within projection field

dXₛ(y), dYₛ(y)=x,y dynamic scan translation error (repeatable part)

YAWₛ(y)=dynamic scan yaw error (repeatable part)

dZₛ(y)=z or piston dynamic scan focus error (repeatable part)

Rₛ(y)=dynamic scan roll error (repeatable part)

Because the scan synchronization is inherently non-repeatable, only the average, or portion of it that repeats from scan to scan, is of interest since it is a candidate for correction.

To assess or measure the repeatable part of scan synchronization error, the methods of U.S. patent application Ser. No. 10/833,781 and U.S. Pat. No. 6,906,303, supra can be used. For example, U.S. Pat. No. 6,906,303, supra describes measurement of the transverse portion (dXₛ(y), dYₛ(y), YAWₛ(y)) on a scan by scan basis or, the average itself (reduced transmission reticle). U.S. patent application Ser. No. 10/833,781, supra describes measurement of the Z portion (dZₛ(y), Rₛ(y)) on a scan by scan basis or measurement of the average itself.

Measure Crossfield Chromatic Lens Response

Returning to FIG. 1, Block 3, the crossfield chromatic lens response is measured. This can be performed, for example, using the method described in “Process And Method For Measurement of Crossfield Chromatic Response of Projection Imaging Systems”, A. Smith et al, U.S. Provisional Patent Application No. 60/627,688, filed Nov. 12, 2004. Again, only the correctible portion of the repeatable system defects need be measured. The output of this step will be the Zernike coefficients as a function of wavelength. For example, if a linear model is sufficient then:

$$Δ {a}_{j} ( x , y ; λ - {λ}_{0} ) = ( λ - {λ}_{0} ) \frac{ⅆ {am}_{j}}{ⅆ λ} ( x , y ) \qquad ( Equation 4 )$$

where;

λ₀=wavelength where aberrations in FIG. 1, Block 2 were determined

$$\frac{da {m}_{j}}{d λ} ( x , j ) = linear chromatic coefficients as determined by the method of U . S .$$

Provisional Patent Application No. 60/627,688, supra

Δaⱼ(x, y; λ−λ₀)=shift in aberration at wavelength λ

The Zernike coefficients at wavelength λ are:
aⱼ(x,y;λ)=aⱼ(x,y;λ₀)+Δaⱼ(x,y;λ−λ₀) (Equation 5)
where:

aⱼ(x, y; λ₀)=Zernike coefficients as determined in FIG. 1, Block 2.
An example of a second order model would be:

$$\begin{matrix}Δ {a}_{j} ( x , y ; λ - {λ}_{0} ) = ( λ - {λ}_{0} ) \frac{ⅆ {am}_{j}}{ⅆ λ} ( x , y ) + \\ \frac{{( λ - {λ}_{0} )}^{2}}{2} \frac{{ⅆ}^{2} {am}_{j}}{ⅆ {λ}^{2}} ( x , y )\end{matrix} \\ where \text{:} \\ \frac{ⅆ {am}_{j}}{ⅆ λ} ( x , y ) and \frac{{ⅆ}^{2} {am}_{j}}{ⅆ {λ}^{2}} ( x , y ) \qquad ( Equation 6 )$$

are the output of the method of U.S. Provisional Patent Application No. 60/627,688, supra and the Zernike coefficients as function of λ are given by Equation 5.
Design Compensating Arrangement

Returning again to FIG. 1, Block 4, a compensating arrangement is designed. In this section the general framework for formulating and solving the optimization is described. Special cases and simplifications are described in various more specific embodiments.

First, the laser or light source spectrum may be represented as the sum of a number, N, of discrete lines with possibly individual lineshapes and relative intensity varying across the projected field.

Expressed as a spectral density ρL we have;

$$\begin{matrix}ρ L ( \overline{x} , λ ) = illumination spectrum at wavelength \\ λ and field point position \overline{x} = ( x , y ) \\ = {\sum }_{j = 1}^{N} {w}_{j} ( \overline{x} ) {S}_{j} ( λ - {λ}_{j} )\end{matrix} \qquad ( Equation 7 )$$

where;

wⱼ(\overline{x})=relative fraction or weight of line number j at point \overline{x}

λⱼ=line number j central wavelength

Sⱼ(λ)=normalized line shape for line number j

Relative weight functions wⱼ(\overline{x}) satisfy:
0≦wⱼ(\overline{x})≦1 (Equation 8)
and since the total intensity is constant

$${\sum }_{j = 1}^{N} {w}_{j} ( \overline{x} ) = 1 \qquad ( Equation 9 )$$

where we have used the line by line spectral normalization condition
∫dλSⱼ(λ)=1 (Equation 10)
From FIG. 1, Block 3, the chromatic response of the system is described by Δaⱼ of Equation 5. In the case of scanners, it is useful to recast the repeatable portion of the synchronization error (Equation 3) as a Zernike aberration that varies with field position. For the transverse portion, this is accomplished by adding to the lens tilt (a2, a3) (x, y) the term

$$\frac{- π NA}{2 λ}$$

(ΔX,ΔY) (x,y) where (ΔX,ΔY) are given in Equation 3. The repeatable portion of the Z-scan error affects all of the azimuthally symmetric (L=0) Zernike coefficients (a4, a11, a22, a37, a56, a79 . . . ). Details of the conversion are described in detail elsewhere (See, for example, “Gauging the Performance of An In-Situ Interferometer”, M. Terry et al) but the final result is that a4, a11, a22 . . . change by

$$\frac{2 π}{λ} {b}_{4 } Δ Z , \frac{2 π}{λ} {b}_{11} Δ Z , \frac{2 π}{λ} {b}_{22} Δ Z …$$

where b4, b11, b22 . . . are NA dependent conversion factors given in “Gauging the Performance of An In-Situ Interferometer”, supra.

The upshot for characterization of dynamically operated scanners is that within the present framework it is possible to combine the measured crossfield Zernike coefficients (aⱼ(x) of Equation 1) and repeatable part of the scan synchronization error (ΔX, ΔY, ΔZ in Equation 7) into a single ‘effective’ set of Zernike coefficients a_{EFFj}(x, y):

$$\begin{matrix}{a}_{EFF 2} ( x , y ) = {a}_{2} ( x ) - \frac{π NA}{2 λ} Δ X ( x , y ) & ( Equation 11 ) \\ {a}_{EFF 3} ( x , y ) = {a}_{3} ( x ) - \frac{π NA}{2 λ} Δ Y ( x , y ) & ( Equation 12 ) \\ {a}_{EFF j} ( x , y ) = {a}_{j} ( x ) + \frac{2 π}{λ} {b}_{j} ( NA ) Δ Z ( x , y ) \\ j = 4 , 11 , 22 , 37 , 56 … & ( Equation 13 ) \\ {a}_{EFF j} ( x , y ) = {a}_{j} ( x ) for other Zernike coefficients & ( Equation 14 )\end{matrix}$$

In the following discussion the ‘EFF’ suffix is dropped when talking about dynamic scans, but we formulate things generally enough that this substitution is simple.

In the presence of the structured illumination spectrum of Equation 7 the phase aberration Φ of Equation 1 becomes:

$$\begin{matrix}{Φ}_{new} ( \overline{n} ; \overline{x} ) = {\sum }_{j} ( {a}_{j} ( \overline{x} ) + δ {a}_{j} ( \overline{x} ) ) {Z}_{j} ( \frac{\overline{n}}{NA} ) \\ where \\ \begin{matrix}{a}_{j} ( \overline{x} ) = aberrations and repeatable defects as determined \\ in Figure 1 , Block 2\end{matrix} & ( Equation 15 ) \\ \begin{matrix}δ {a}_{j} ( x ) = \int ⅆ λ {ρ}_{L} ( \overline{x} , λ ) Δ {a}_{j} ( \overline{x} , λ - {λ}_{0} ) \\ = {\sum }_{l} {w}_{l} ( \overline{x} ) \int ⅆ λ {S}_{l} ( λ - {λ}_{l} ) Δ {a}_{j} ( \overline{x} , λ - {λ}_{0} )\end{matrix} & ( Equation 16 )\end{matrix}$$

and Δaⱼ is the lens chromatic response as determined in FIG. 1, Block 3.
Typically it is desirable to minimize Φ_{new}(\overline{x}) e.g.,

$${σ}^{2} ( \overline{x} ) = \int {ⅆ}^{2} n {Φ}_{eff}^{2} ( \overline{n} ; \overline{x} ) = {\sum }_{j} {( {a}_{j} ( \overline{x} ) + δ {a}_{j} ( \overline{x} ) )}^{2} \qquad ( Equation 17 )$$

Computationally it is best to express the constraint of Equation 9 explicitly as

$${w}_{N} ( x ) = 1 - {\sum }_{l = 1}^{N - 1} {w}_{l} ( x ) \qquad ( Equation 18 )$$

and then δaⱼ(\overline{x}) in Equation 16 becomes:

$$\begin{matrix}δ {a}_{j} ( \overline{x} ) = \int ⅆ λ {S}_{N} ( λ - {λ}_{N} ) Δ {a}_{j} ( \overline{x} , λ - {λ}_{0} ) + \\ {\sum }_{l = 1}^{N - 1} {w}_{l} ( \overline{x} ) [ \begin{matrix}\int ⅆ λ ( {S}_{l} ( λ - {λ}_{l} ) - \\ {S}_{N} ( λ - {λ}_{N} ) ) Δ {a}_{j} ( \overline{x} , λ - {λ}_{0} )\end{matrix} ]\end{matrix} \qquad ( Equation 19 )$$

Uniform Chromatic Response, Spatial Variation Only

$$\begin{matrix}Δ {a}_{j} ( \overline{x} , λ - {λ}_{0} ) is independent of \overline{x} e . g . , it is a function of λ - {λ}_{0} only . Then \text{:} \\ δ {a}_{j} ( \overline{x} ) = {A}_{N , j} + {\sum }_{l = 1}^{N - 1} {w}_{l} ( \overline{x} ) {B}_{l , j} & ( Equation 20 ) \\ where ; & \\ {A}_{N , j} = \int ⅆ {λS}_{N} ( λ - {λ}_{N} ) Δ {a}_{j} ( λ - {λ}_{0} ) & ( Equation 21 ) \\ {B}_{l , j} = \int ⅆ λ [ {S}_{l} ( λ - {λ}_{l} ) - {S}_{N} ( λ - {λ}_{N} ) ] Δ {a}_{j} ( λ - {λ}_{0} ) & ( Equation 22 )\end{matrix}$$

For the current problem, do not vary the spectrum or λ center (λl) so A_{N,j} and B_{l,j} above are constants. Typically it is beneficial to minimize σ²(x) at the worst points or regions of the field. Minimizing the average value of σ²(x) over the field will tend to reduce the variation at the worst points.

$$\begin{matrix}〈 {σ}^{2} 〉 = {\int }_{A} \frac{{ⅆ}^{2} x}{A} {σ}^{2} ( x ) \\ = {\sum }_{j} {( {a}_{j} ( \overline{x} ) - {A}_{N , j} - {\sum }_{l = 1}^{N - 1} {w}_{l} ( \overline{x} ) {B}_{l , j} )}^{2}\end{matrix} \qquad ( Equation 23 )$$

minimizing Equation 23 means

$$\begin{matrix}\begin{matrix}\frac{δ 〈 {σ}^{2} 〉}{δ {w}_{l} ( {\overline{x}}^{′} )} = {\sum }_{j} - 2 {B}_{l , j} \int \frac{ⅆ \overline{x}}{A} {δ}^{2} ( {\overline{x}}^{′} - \overline{x} ) \\ ( {a}_{j} ( \overline{x} ) - {A}_{N , j} - {\sum }_{{l}^{′} = 1}^{N - 1} {w}_{{l}^{′}} ( x ) {B}_{{l}^{′} , j} ) \\ = 0\end{matrix} & ( Equation 24 ) \\ or & \\ \begin{matrix}{\sum }_{j} {B}_{l , j} ( {a}_{j} ( {\overline{x}}^{′} ) - {A}_{N , j} ) = {\sum }_{j} {B}_{l , j} {\sum }_{{l}^{′} = 1}^{N - 1} {w}_{{l}^{′}} ( {\overline{x}}^{′} ) {B}_{{l}^{′} , j} \\ = {\sum }_{{l}^{′} = 1}^{N - 1} {W}_{{l}^{′}} ( {\overline{x}}^{′} ) {\sum }_{j} {B}_{l , j} {B}_{{l}^{′} , j}\end{matrix} & ( Equation 25 )\end{matrix}$$

If wₗ(\overline{x}) is expanded into orthonormal spatial modes, Pᵢ(\overline{x}) as:

$$\begin{matrix}{W}_{l} ( \overline{x} ) = {\sum }_{i} {P}_{i} ( \overline{x} ) {w}_{i , l} & ( Equation 26 ) \\ then & \\ \int \frac{{ⅆ}^{2} x}{A} {P}_{i} ( \overline{x} ) {\sum }_{j} {B}_{l , j} ( {a}_{j} ( \overline{x} ) - {A}_{N , j} ) = {\sum }_{{l}^{′} = 1}^{N - 1} {w}_{i , l} {C}_{l , {l}^{′}} & ( Equation 27 ) \\ where & \\ {C}_{l , {l}^{′}} = {\sum }_{j} {B}_{l , j} {B}_{{l}^{′} , j} & ( Equation 28 )\end{matrix}$$

Equation 27 is easily solved (See Numerical Recipes, The Art of Scientific Computing, W. Press et al, Cambridge University, 52:64, 1990), but the 0:1 interval constraints (Equation 8) need to be satisfied. By employing penalty function or Lagrange multiplier techniques (See “Optimization Theory with Applications”, D. Pierre, Dover Publications, 332:343) we can iteratively solve Equation 27 and still satisfy Equation 8 for the final answer.
Non Constant Chromatic Response

Non constant chromatic response can be determined by expressing wₗ(\overline{x}) in terms of orthonormal functions over A as in Equation 26, then Equation 19 becomes:

$$\begin{matrix}δ {a}_{j} ( \overline{x} ) = \int ⅆ λ {S}_{N} ( λ - {λ}_{N} ) Δ {a}_{j} ( \overline{x} , λ - {λ}_{0} ) + \\ {\sum }_{i} {{\sum }^{N - 1}}_{l = 1} {w}_{i , l} {P}_{i} ( \overline{x} ) \\ [ \int ⅆ λ ( {S}_{l} ( λ - {λ}_{l} ) - {S}_{N} ( λ - {λ}_{N} ) ) Δ {a}_{j} ( \overline{x} , λ - {λ}_{0} ) ]\end{matrix}$$

and further expressing the spatial structure of Δaⱼ(\overline{x}, λ−λ₀) as:

$$Δ {a}_{j} ( \overline{x} , λ - {λ}_{0} ) = {\sum }_{i} {P}_{i} ( \overline{x} ) Δ {a}_{j , i} ( λ - {λ}_{0} )$$

and utilizing the orthonormality of the Pᵢ's and expressing the product of two Pᵢ's as:

$${P}_{i} ( \overline{x} ) {P}_{{i}^{′}} ( \overline{x} ) = {\sum }_{{i}^{′′} = 1}^{n ( i , {i}^{′} )} {P}_{{i}^{′′}} ( i , {i}^{′} ) {P}_{{i}^{′′}} ( \overline{x} ) \qquad ( Equation 29 )$$

the equation for δaⱼ(\overline{x}) can be reduced to one (1) depending on unknown parameters only. This equation when combined with the 0:1 constraint (Equation 8) is then iteratively solved as described in “Optimization Theory with Applications”, supra.
Build and Install Compensating Arrangement

Returning to FIG. 1, Block 5, the compensating arrangement is built and installed onto the lithographic projection system.

Exemplary Embodiment for Correction of Dynamic Scan Field Curvature

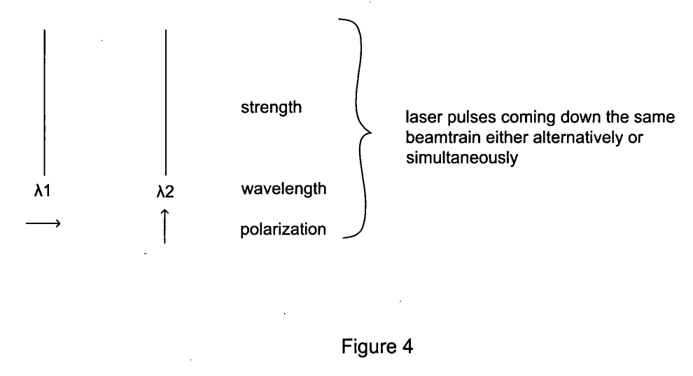

As illustrated in FIG. 1, Block 1, an illumination source is provided that can operate simultaneously, or alternately, at two or more discrete wavelength settings. FIG. 4 shows an exemplary laser illumination source that can be used. FIG. 4 illustrates an exemplary illumination source with X and Y polarization and equal strength.

The repeatable system defect we wish to compensate, dynamic lens field curvature or a4(x) is measured as illustrated in FIG. 1, Block 2. For example, the method of U.S. patent application Ser. No. 10/833,557, supra may be applied to measure it.

Then as illustrated in FIG. 1, Block 3, the crossfield lens chromatic response

$$\frac{ⅆ a 4}{ⅆ λ} ( x )$$

or

$$\frac{ⅆ z}{ⅆ λ} ( x )$$

is determined. This can be measured, for example, by the technique of U.S. Provisional Patent Application No. 60/627,688, supra.

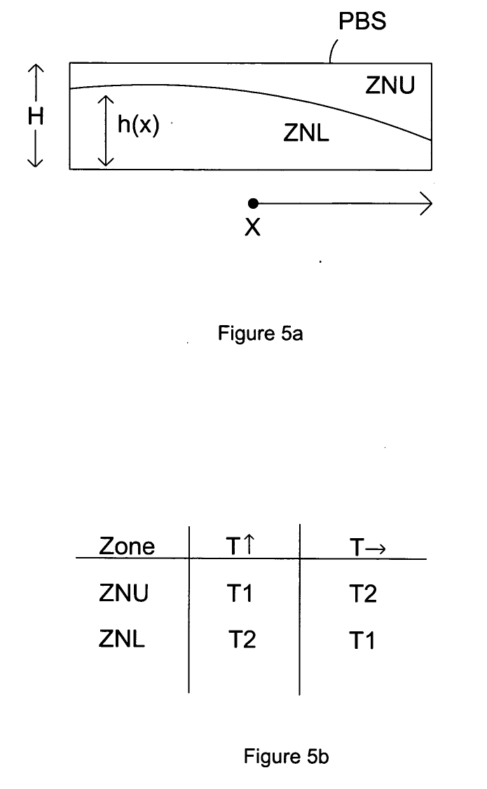

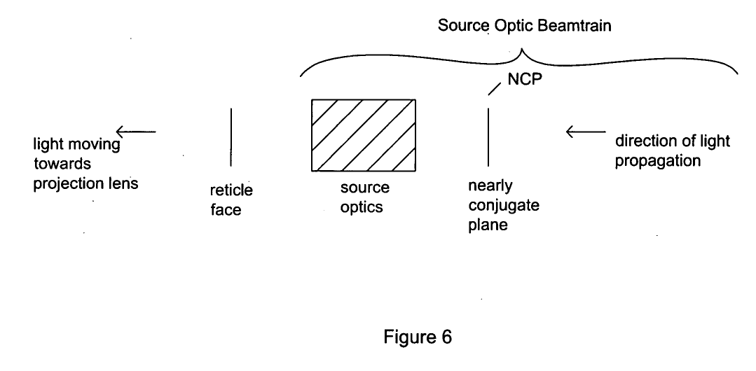

Then, as illustrated in FIG. 1, Blocks 4 and 5, a compensating arrangement is designed, built, and installed. Referring to FIG. 5a, a dual zone polarizing beam splitter with variable height h(x) and transmissions in each zone is shown in FIG. 5b. FIG. 6 is a block diagram illustrating the polarizing beam splitter placed in the source optics beamtrain at a plane conjugate or nearly conjugate (NCP) to the reticle face.

Because of the averaging effect in a scanner, the weights for wavelengths λ1 and λ2 are:

$$\begin{matrix}w 1 ( x ) = \frac{T 2}{T 1 + T 2} \frac{h ( x )}{H} + \frac{T 1}{T 1 + T 2} ( 1 - \frac{h ( x )}{H} ) & ( Equation 30 ) \\ w 2 ( x ) = \frac{T 1}{T 1 + T 2} \frac{h ( x )}{H} + \frac{T 2}{T 1 + T 2} ( 1 - \frac{h ( x )}{H} ) & ( Equation 31 )\end{matrix}$$

so the focus delivered is:

$$\begin{matrix}a {4}_{new} ( x ) = {a}_{4} ( x ) + Δ {λ}_{1} \frac{ⅆ a 4}{ⅆ λ} ( x ) {w}_{1} ( x ) + \\ Δ {λ}_{2} \frac{ⅆ a 4}{ⅆ λ} ( x ) {w}_{2} ( x ) \\ = {a}_{4} ( x ) + Δ {λ}_{2} \frac{ⅆ a 4}{ⅆ λ} ( x ) + ( Δ {λ}_{1} - Δ {λ}_{2} ) \\ \frac{ⅆ a 4}{ⅆ λ} ( x ) {w}_{1} ( x )\end{matrix} \qquad ( Equation 32 )$$

To eliminate field curvature we set a4_{new}(x)=0 to get:

$$w 1 ( x ) = \frac{[ {a}_{4} ( x ) + Δ {λ}_{2} \frac{ⅆ a 4}{ⅆ λ} ( x ) ]}{( Δ {λ}_{2} - Δ {λ}_{1} ) \frac{ⅆ a 4}{ⅆ λ} ( x )} \qquad ( Equation 33 )$$

Equation 9 limits w1 to the 0:1 range, however our particular construction places additional constraints on w1 through Equation 30. Since h(x)/H is in the range 0:1 we get

$${w}_{lo} = \frac{min ( T 1 , T 2 )}{T 1 + T 2} \leq w 1 ( x ) \leq \frac{max ( T 1 , T 2 )}{T 1 + T 2} = {w}_{hi} \qquad ( Equation 34 )$$

Typically, the chromatic response

$$\frac{ⅆ a 4}{ⅆ λ} ( x )$$

will be largely independent of position x.
Denoting:

$${Δ}_{2} = Δ {λ}_{2} \frac{ⅆ a 4}{ⅆ λ} \\ {Δ}_{1} = Δ {λ}_{1} \frac{ⅆ a 4}{ⅆ λ} \qquad ( Equation 35 )$$

we can always arrange Δ₂−Δ₁>0. Then denoting the max/min a4(x) values across the field as a4^{max}/a4^{min} we require

$$\begin{matrix}\frac{a {4}^{max} + {Δ}_{2}}{{Δ}_{2} - {Δ}_{1}} < {w}_{hi} & ( Equation 36 ) \\ and & \\ \frac{a {4}^{min} + {Δ}_{2}}{{Δ}_{2} - {Δ}_{1}} < {w}_{lo} & ( Equation 37 )\end{matrix}$$

Equations 36 and 37 are algebraically equivalent to the two conditions:
a4^{max}≦−[Δ2(1−wₕᵢ)+Δ₁*wₕᵢ] (Equation 38)
and
a4^{min}≧−[Δ2(1−wₗₒ)+Δ₁*wₗₒ] (Equation 39)
These are readily satisfied by appropriate choice of wavelength λ1 and λ2.
The variable zone height is then:

$$\frac{h ( x )}{H} = \frac{( T 1 + T 2 ) w 1 ( x ) - T 1}{T 2 - T 1} \qquad ( Equation 40 )$$

Exemplary Embodiment for Correction of Dynamic Scan Z-Synchronization Error

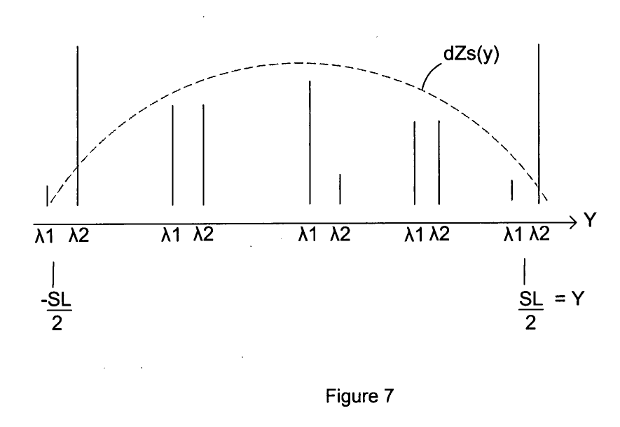

Again as illustrated in FIG. 1, Block 1, an illumination source that can operate simultaneously, or alternately, at two or more discrete wavelength settings is provided. FIG. 7 shows an exemplary laser illumination source that can be used. FIG. 7 illustrates exemplary spectral weights of λ, and λ_{Z} with relative strengths that vary over the course of the scan to compensate for the piston portion (dZₛ(y) of Equation 3) of the dynamic scan error.

Then, dZₛ(y) or dynamic piston error is measured as illustrated in FIG. 1, Block 2. This error can, be measured, for example, using the method described in U.S. patent application Ser. No. 10/833,557, supra.

Then, as illustrated in FIG. 1, Block 3, the crossfield lens chromatic response

$$\frac{ⅆ a 4}{ⅆ λ}$$

or

$$\frac{ⅆ z}{ⅆ λ}$$

is determined. This response can be measured for example by the techniques of U.S. Provisional Patent Application No. 60/627,688, supra. It will be independent of the scan direction y, and its average value in the cross-scan direction (x) can be used since this transformation takes place before the spatially homogenizing optics.

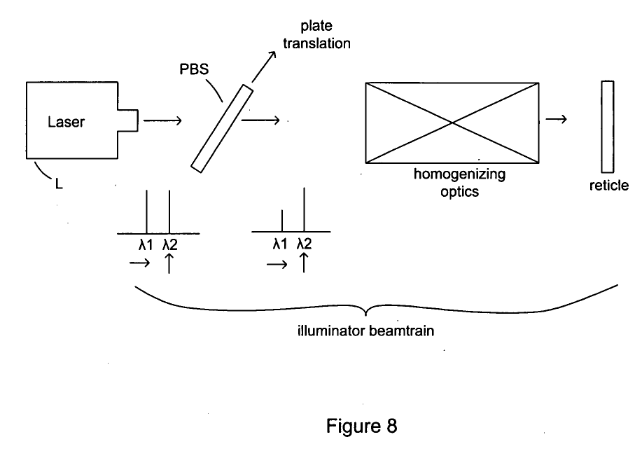

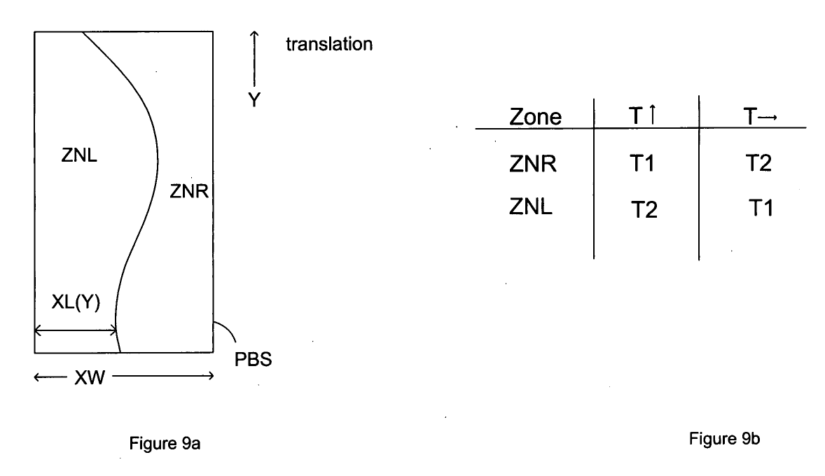

Then, as illustrated in FIG. 1, Blocks 4 and 5, a compensating arrangement is designed, built, and installed. FIG. 8 shows a schematic of an exemplary illuminator beamtrain. In this example, laser, L, emits a double spectral pulse (FIG. 3b), each pulse having different polarizations (X at λ1, Y at λ2). These pulses can be emitted either simultaneously or as alternate pulses by laser, L. The strength of the two pulses are approximately equal as they come out. Next, and before any significant beam homogenization has occurred, a polarizing beam splitter having two zones is struck by light from laser L and its output consists of the two pulses but of different weights. Polarizing beam splitter, PBS, is gradually translated over the duration of the scan (˜0.3 sec) and the relative intensities vary so that dynamic piston is compensated (FIG. 7). FIGS. 9a and 9b show the face of an exemplary dual zone PBS and the transmissions of each zone.

Because of the finite (=YH) beam height impinging on the PBS (FIG. 9a) the weights at wavelengths λ1 and λ2 are:

$$\begin{matrix}w 1 ( y ) = \frac{T 2}{T 1 + T 2} f ( y ) + \frac{T 1}{T 1 + T 2} ( 1 - f ( y ) ) & ( Equation 41 ) \\ w 2 ( y ) = 1 - w 1 ( y ) \\ where & ( Equation 42 ) \\ f ( y ) = {\int }_{\frac{- YH}{2}}^{\frac{YH}{2}} \frac{ⅆ s}{YH} \frac{x 1 ( y + s )}{xw} & ( Equation 43 )\end{matrix}$$

is the moving average of the window x1—width.
The delivered field curvature is then:

$$\begin{matrix}\begin{matrix}{dZ}_{ S}^{ new} ( y ) = {dZ}_{ s} ( y ) + Δ {λ}_{ 1} \frac{ⅆ Z}{ⅆ λ} {w}_{ 1} ( y ) + \\ Δ {λ}_{ 2} \frac{ⅆ Z}{ⅆ λ} w 2 ( λ ) \\ = {dZ}_{ s} ( y ) + {Δ}_{ 2} + \\ ( {Δ}_{ 1} - {Δ}_{ 2} ) {w}_{ 1 } ( y )\end{matrix} & \begin{matrix}\begin{matrix}\begin{matrix}\begin{matrix}\begin{matrix}( Equation 44 ) \\ \end{matrix} \\ \end{matrix} \\ \end{matrix} \\ ( Equation 45 )\end{matrix} \\ \end{matrix} \\ where \\ {Δ}_{ 1} / {Δ}_{ 2} = Δ {λ}_{ 1} \frac{ⅆ Z}{ⅆ λ} / Δ {λ}_{2} \frac{ⅆ Z}{ⅆ λ} & ( Equation 46 )\end{matrix}$$

To eliminate field curvature we would set dZₛ^{new}(y)=0 and solve for w₁(y) to get:

$$w 1 ( y ) = \frac{{dZ}_{s} ( y ) + {Δ}_{2}}{Δ 2 - Δ 1} \qquad ( Equation 47 )$$

As before, there are limits on w1 imposed by our hardware arrangement so:

$${w}_{lo} = \frac{min ( T 1 , T 2 )}{T 1 + T 2} \leq w 1 ( y ) \leq \frac{max ( T 1 , T 2 )}{T 1 + T 2} = {w}_{hi} \qquad ( Equation 48 )$$

Equation 48 places a constraint on the wavelength positions as:
max(dZₛ(y)≦−[Δ2(1−wₕᵢ)+Δ1*wₕᵢ] (Equation 49)
min(dZₛ(y)≧−[Δ2(1−wₗₒ)+Δ1*wₗₒ] (Equation 50)
Then we can solve for f(y) as:

$$f ( y ) = \frac{( T 1 + T 2 ) w 1 ( y ) - T 1}{T 2 - T 1} \qquad ( Equation 51 )$$

The constructional function x1(y) is recovered by deconvolving Equation 43 using the now known form of f(y).

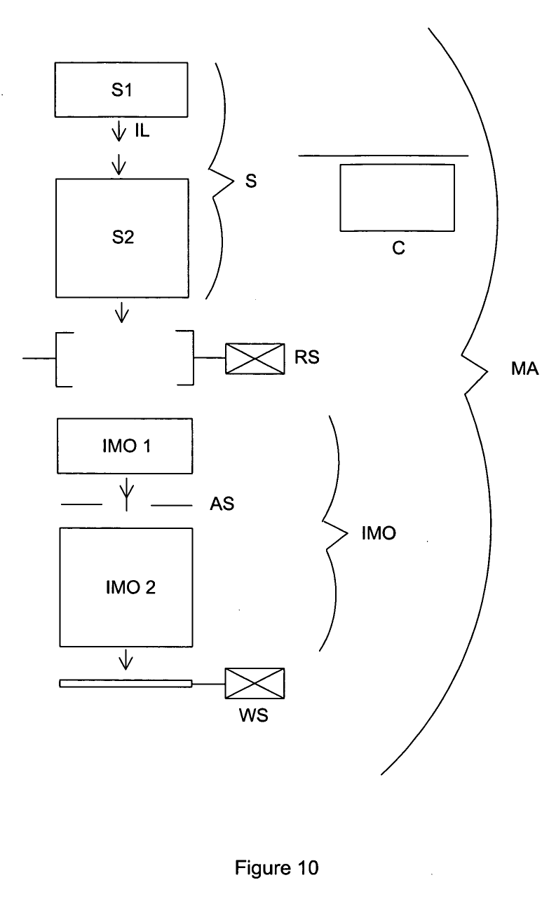

FIG. 10 is a schematic diagram of an example of a projection imaging tool or machine (MA) that can be used in the manufacturing of semiconductor integrated circuits. As shown in the example in FIG. 10, the MA includes a light source S, a reticle stage RS, imaging objective IMO, wafer stage WS, and a controller C. The light source can include an illumination source S1 that outputs illumination light IL that either simultaneously, or alternately, outputs illumination at two or more discrete wavelength settings. For example, the illumination source can include a mercury lamp with a notch rejection filter, or an excimer laser with a notch rejection filter. The light source can also include a compensating arrangement S2 that compensates for lens field curvature and other imaging defects. The IMO can include an upper imaging objective IMO1, a lower imaging objective IMO2, and an aperture stop AS.

The controller C can adjust the operation of the projection imaging tool in response to received measurements. For example, the controller can adjust the operation of the reticle stage RS, the illumination source S, the wafer stage WS, or other operations of the projection imaging tool. The compensated projection imaging tool may be used to expose a substrate, for example, a substrate that is positioned by the wafer stage WS at the output of the imaging objective IMO for a semiconductor integrated circuit manufacturing process.

The foregoing description details certain embodiments of the invention. It will be appreciated, however, that no matter how detailed the foregoing appears, the invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes which come with the meaning and range of equivalency of the claims are to be embraced within their scope.

We claim:

1. A method for correcting imaging defects in a projection imaging tool, the method comprising:
providing an illumination source with an output at two or more discrete wavelength settings;
measuring repeatable imaging defects of the projection imaging tool;
measuring crossfield lens chromatic response; and
designing a compensating arrangement for use in the projection imaging tool to correct imaging defects.

2. A method as defined in claim 1, wherein the crossfield chromatic response comprises tilt distortion.

3. A method as defined in claim 1, wherein the crossfield chromatic response comprises lens distortion.

4. A method as defined in claim 1, wherein the repeatable imaging defects comprise stage translation errors.

5. A method as defined in claim 1, wherein the repeatable imaging defects comprise scan synchronization error.

6. A method as defined in claim 1, wherein the repeatable imaging defects comprise dynamic lens field curvature.

7. A method as defined in claim 1, wherein the compensating arrangement comprises a dual zone polarizing beam splitter.

8. A method as defined in claim 1, wherein the illumination source comprises a mercury lamp and a notch rejection filter.

9. A method as defined in claim 1, wherein the illumination source comprises an excimer laser and a notch rejection filter.

10. An apparatus for correcting imaging defects in a projection imaging tool, the apparatus comprising:
an illumination source configured to have an output at two or more discrete wavelength settings, wherein the illumination source is used to measure repeatable imaging defects and crossfield lens chromatic response of the projection imaging tool; and
a compensating arrangement used in the projection imaging tool to correct imaging defects.

11. An apparatus as defined in claim 10, wherein the crossfield chromatic response comprises tilt distortion.

12. An apparatus as defined in claim 10, wherein the crossfield chromatic response comprises lens distortion.

13. An apparatus as defined in claim 10, wherein the repeatable imaging defects comprise stage translation errors.

14. An apparatus as defined in claim 10, wherein the repeatable imaging defects comprise scan synchronization error.

15. An apparatus as defined in claim 10, wherein the repeatable imaging defects comprise dynamic lens field curvature.

16. An apparatus as defined in claim 10, wherein the compensating arrangement comprises a dual zone polarizing beam splitter.

17. A method as defined in claim 10, wherein the illumination source comprises a mercury lamp and a notch rejection filter.

18. A method as defined in claim 10, wherein the illumination source comprises an excimer laser and a notch rejection filter.

19. A method for manufacturing a semiconductor device, the method comprising:
providing an illumination source with an output at two or more discrete wavelength settings;
measuring repeatable imaging defects of the projection imaging tool;
measuring crossfield lens chromatic response;
designing a compensating arrangement for use in the projection imaging tool to correct imaging defects; and
exposing one or more layers of the semiconductor device with the projection imaging tool.

20. A method as defined in claim 19, wherein the crossfield chromatic response comprises tilt distortion.

21. A method as defined in claim 19, wherein the crossfield chromatic response comprises lens distortion.

22. A method as defined in claim 19, wherein the repeatable imaging defects comprise stage translation errors.

23. A method as defined in claim 19, wherein the repeatable imaging defects comprise scan synchronization error.

24. A method as defined in claim 19, wherein the repeatable imaging defects comprise dynamic lens field curvature.

25. A method as defined in claim 19, wherein the compensating arrangement comprises a dual zone polarizing beam splitter.

26. A method as defined in claim 19, wherein the illumination source comprises a mercury lamp and a notch rejection filter.

27. A method as defined in claim 19, wherein the illumination source comprises an excimer laser and a notch rejection filter.

28. An apparatus for manufacturing a semiconductor device, the apparatus comprising:
an illumination source configured to have an output at two or more discrete wavelength settings, wherein the illumination source is used to measure repeatable imaging defects and crossfield lens chromatic response of the projection imaging tool;
a compensating arrangement used in the projection imaging tool to correct imaging defects; and
a reticle, wherein the illumination source and compensating arrangement cooperate to expose a pattern onto on or more layers of the semiconductor device.
